(19) United States
(12) Patent Application Publication
(10) Pub. No.: US 2020/0216052 A1
(43) Pub. Date: Jul. 9, 2020

(54) VEHICLE BRAKE SYSTEM WITH AUXILIARY CONTROL UNIT

(71) Applicant: ZF Active Safety US Inc., Livonia, MI (US)

(72) Inventor: Gregory P. Campau, Plymouth, MI (US)

(73) Assignee: ZF Active Safety US Inc., Livonia, MI (US)

(21) Appl. No.: 16/715,510

(22) Filed: Dec. 16, 2019

Related U.S. Application Data
(60) Provisional application No. 62/783,925, filed on Dec. 21, 2018.

(51) Int. Cl. B60T 13/68; B60T 13/14; B60T 13/66; B60T 17/04; B60T 17/22

(52) U.S. Cl. CPC B60T 13/686; B60T 13/141; B60T 17/22; B60T 17/04; B60T 13/662

(57) ABSTRACT

A brake system includes a fluid reservoir, a brake pedal unit, a first source of pressurized fluid, a pump assembly, and a valve for selectively closing off communication between an inlet of the pump assembly and the brake pedal unit. The brake pedal unit includes a housing and a pair of pistons slidably disposed in the housing. The pair of pistons are movable to generate brake actuating pressure at first and second outputs for actuating at least one wheel brake within a first circuit and a second circuit, respectively. The first source of pressurized fluid actuates the at least one wheel brake under normal braking conditions. The pump assembly actuates the at least one wheel brake under a manual push-through mode.

### CROSS-REFERENCE TO RELATED APPLICATION

This application claims priority to U.S. Provisional Patent Application No. 62/783,925, filed Dec. 21, 2018, the disclosure of which is incorporated herein by reference in its entirety.

### BACKGROUND

This invention relates in general to vehicle braking systems. Vehicles are commonly slowed and stopped with hydraulic brake systems. These systems vary in complexity but a base brake system typically includes a brake pedal, a tandem master cylinder, fluid conduits arranged in two similar but separate brake circuits, and wheel brakes in each circuit. The driver of the vehicle operates a brake pedal which is connected to the master cylinder. When the brake pedal is depressed, the master cylinder generates hydraulic forces in both brake circuits by pressurizing brake fluid. The pressurized fluid travels through the fluid conduit in both circuits to actuate brake cylinders at the wheels to slow the vehicle. Base brake systems typically use a brake booster which provides a force to the master cylinder which assists the pedal force created by the driver. The booster can be vacuum or hydraulically operated. A typical hydraulic booster senses the movement of the brake pedal and generates pressurized fluid which is introduced into the master cylinder. The fluid from the booster assists the pedal force acting on the pistons of the master cylinder which generate pressurized fluid in the conduit in fluid communication with the wheel brakes. Thus, the pressures generated by the master cylinder are increased. Hydraulic boosters are commonly located adjacent the master cylinder piston and use a boost valve to control the pressurized fluid applied to the booster.

Braking a vehicle in a controlled manner under adverse conditions requires precise application of the brakes by the driver. Under these conditions, a driver can easily apply excessive braking pressure thus causing one or more wheels to lock, resulting in excessive slippage between the wheel and road surface. Such wheel lock-up conditions can lead to greater stopping distances and possible loss of directional control.

Advances in braking technology have led to the introduction of Anti-lock Braking Systems (ABS). An ABS system monitors wheel rotational behavior and selectively applies and relieves brake pressure in the corresponding wheel brakes in order to maintain the wheel speed within a selected slip range to achieve maximum braking force. While such systems are typically adapted to control the braking of each braked wheel of the vehicle, some systems have been developed for controlling the braking of only a portion of the plurality of braked wheels.

Electronically controlled ABS valves, comprising apply valves and dump valves, are located between the master cylinder and the wheel brakes. The ABS valves regulate the pressure between the master cylinder and the wheel brakes. Typically, when activated, these ABS valves operate in three pressure control modes: pressure apply, pressure dump and pressure hold. The apply valves allow pressurized brake fluid into respective ones of the wheel brakes to increase pressure during the apply mode, and the dump valves relieve brake fluid from their associated wheel brakes during the dump mode. Wheel brake pressure is held constant during the hold mode by dosing both the apply valves and the dump valves. To achieve maximum braking forces while maintaining vehicle stability, it s desirable to achieve optimum slip levels at the wheels of both the front and rear axles. During vehicle deceleration different braking forces are required at the front and rear axles to reach the desired slip levels. Therefore, the brake pressures should be proportioned between the front and rear brakes to achieve the highest braking forces at each axle. ABS systems with such ability, known as Dynamic Rear Proportioning (DRP) systems, use the ABS valves to separately control the braking pressures on the front and rear wheels to dynamically achieve optimum braking performance at the front and rear axles under the then current conditions.

A further development in braking technology has led to the introduction of Traction Control (TC) systems. Typically, valves have been added to existing ABS systems to provide a brake system which controls wheel speed during acceleration. Excessive wheel speed during vehicle acceleration leads to wheel slippage and a loss of traction. An electronic control system senses this condition and automatically applies braking pressure to the wheel cylinders of the supping wheel to reduce the slippage and increase the traction available. In order to achieve optimal vehicle acceleration, pressurized brake fluid is made available to the wheel cylinders even if the master cylinder is not actuated by the driver.

During vehicle motion such as cornering, dynamic forces are generated which can reduce vehicle stability. A Vehicle Stability Control (VSC) brake system improves the stability of the vehicle by counteracting these forces through selective brake actuation. These forces and other vehicle parameters are detected by sensors which signal an electronic control unit. The electronic control unit automatically operates pressure control devices to regulate the amount of hydraulic pressure applied to specific individual wheel brakes. In order to achieve optimal vehicle stability, braking pressures greater than the master cylinder pressure must quickly be available at all times.

Brake systems may also be used for regenerative braking to recapture energy. An electromagnetic force of an electric motor/generator is used in regenerative braking for providing a portion of the braking torque to the vehicle to meet the braking needs of the vehicle. A control module in the brake system communicates with a powertrain control module to provide coordinated braking during regenerative braking as well as braking for wheel lock and skid conditions. For example, as the operator of the vehicle begins to brake during regenerative braking, electromagnet energy of the motor/generator will be used to apply braking torque (i.e., electromagnetic resistance for providing torque to the powertrain) to the vehicle. If it is determined that there is no longer a sufficient amount of storage means to store energy recovered from the regenerative braking or if the regenerative braking cannot meet the demands of the operator, hydraulic braking will be activated to complete all or part of the braking action demanded by the operator. Preferably, the hydraulic braking operates in a regenerative brake blending manner so that the blending is effectively and unnoticeably picked up where the electromagnetic braking left off. It is desired that the vehicle movement should have a smooth transitional change to the hydraulic braking such that the changeover goes unnoticed by the driver of the vehicle.

Brake systems may also include autonomous braking capabilities such as adaptive cruise control (ACC), During an autonomous braking event, various sensors and systems monitor the traffic conditions ahead of the vehicle and automatically activate the brake system to decelerate the vehicle as needed. Autonomous braking may be configured to respond rapidly in order to avoid an emergency situation. The brake system may be activated without the driver depressing the brake pedal or even if the driver fails to apply adequate pressure to the brake pedal. Advanced autonomous braking systems are configured to operate the vehicle without any driver input and rely solely on the various sensors and systems that monitor the traffic conditions surrounding the vehicle.

### SUMMARY

A brake system is provided which includes a fluid reservoir, a brake pedal unit, a first source of pressurized fluid, a second source of pressurized fluid, a pump assembly, and a valve. The brake pedal unit is in fluid communication with the fluid reservoir. The brake pedal unit includes a housing and a pair of pistons slidably disposed in the housing. The pistons are operable during a manual push-through mode such that the pair of pistons are movable to generate brake actuating pressure at first and second outputs for actuating at least one wheel brake within a first and second circuit respectively. The first source of pressurized fluid actuates the at least one wheel brake under normal braking conditions. The pump assembly actuates the at least one wheel brake during the manual push-through mode. The valve selectively closes off fluid communication between an inlet of the pump assembly and the brake pedal unit. The pump assembly and the valve are disposed within an auxiliary EHCU which is configured to provide a fail-safe feature so as to actuate the at least one wheel brake in the event that the manual push through mode arises. It is understood that the aforementioned valve may be a normally closed solenoid actuated valve.

The aforementioned brake system may further include a stored volume accumulator separate from the fluid reservoir wherein the stored volume accumulator is in fluid communication with an inlet of the pump assembly. The stored volume accumulator may also include an accumulator piston slidably mounted therein having a first end defining a fluid pressure chamber, and wherein a second end of the piston defines an air-filled chamber at atmospheric pressure, The second source of pressurized fluid may include a pump assembly having an electric motor and a pump. It is understood that the first source of pressurized fluid may include a plunger assembly.

In another embodiment of the present disclosure, a brake system is provided which includes a fluid reservoir, a brake pedal unit, a first source of pressurized fluid, a pump assembly, a valve and an accumulator. The brake pedal unit maybe in fluid communication with the fluid reservoir. The brake pedal unit may include a housing and a pair of pistons slidably disposed in the housing. The aforementioned pistons are operable during a manual push-through mode such that the pair of pistons are movable to generate brake actuating pressure at first and second outputs conduits which are in fluid communication with first and second circuits within the braking system respectively. The brake system of this embodiment further includes a first source of pressurized fluid, a pump assembly, a valve and an accumulator. The first source of pressurized fluid is configured to actuate at least one wheel brake under normal braking conditions. The pump assembly is also configured to actuates at least one wheel brake under the manual push-through mode. The valve is configured to selectively close off fluid communication between an inlet of the pump assembly and the brake pedal unit. The accumulator is provided downstream of the valve may initially provide a pressure medium stored within the accumulator to the pump. The pump assembly and the valve may be disposed within an auxiliary EHCU. This auxiliary EHCU is configured to provide a fail-safe feature so as to actuate at least one wheel brake when in manual push through mode.

With respect to the aforementioned embodiment, it is understood that the valve is configured to open upon exhausting the pressure medium from the accumulator so that an additional pressure medium may then be drawn from a brake conduit to a wheel brake. The aforementioned valve and accumulator may dedicated for use with the at least one wheel brake which corresponds to the valve and the accumulator. The present embodiment may further include a second valve, a second pump, and a second accumulator disposed within the auxiliary EHCU wherein the second accumulator is disposed downstream of the second valve. The second accumulator is configured to initially feed pressure medium stored within the second accumulator to the second pump, and when the pressure medium is exhausted from the second accumulator, the second valve may be configured to open so that a second brake conduit can deliver pressure medium to a second corresponding wheel brake while the first brake conduit is simultaneously delivering pressure medium to the at least one wheel brake which corresponds to the first brake circuit.

### BRIEF DESCRIPTION OF THE DRAWINGS

FIG. 1 is a schematic illustration of a first embodiment of a brake system.

FIG. 2 is an enlarged schematic illustration of the plunger assembly of the brake system of FIG. 1.

FIG. 3 is a schematic illustration of a second embodiment of a brake system.

FIG. 4 is an enlarged schematic view of the stored volume accumulator of the brake system of FIG. 3.

### DETAILED DESCRIPTION

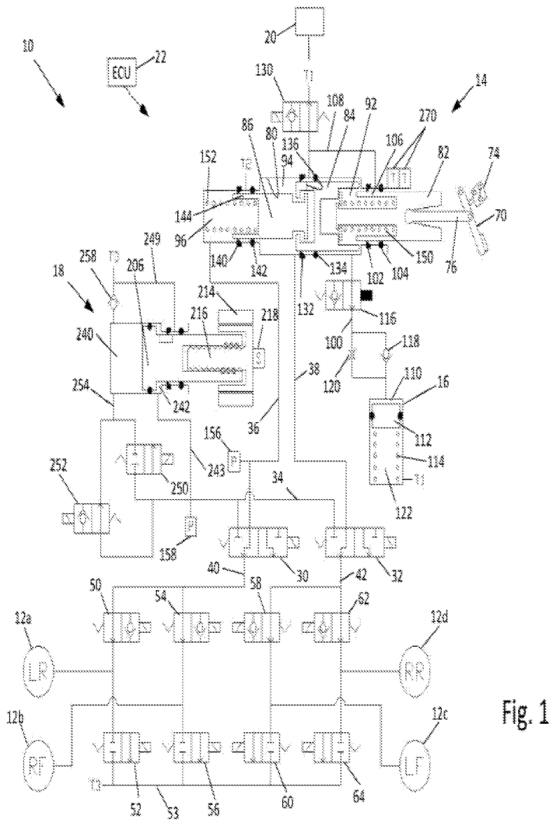

Referring now to the drawings, there is schematically illustrated in FIG. 1 a first embodiment of a vehicle brake system, indicated generally at 10. The brake system 10 is a hydraulic braking system in which fluid pressure from a source is operated to apply braking forces for the brake system 10. The brake system 10 may suitably be used on a ground vehicle such as an automotive vehicle having four wheels. Furthermore, the brake system 10 can be provided with other braking functions such as anti-lock braking (ABS) and other slip control features to effectively brake the vehicle, as will be discussed below. In the illustrated embodiment of the brake system 10, there are four wheel brakes 12a, 12b, 12c, and 12d. The wheel brakes 12a, 12b, 12c, and 12d can have any suitable wheel brake structure operated by the application of pressurized brake fluid. The wheel brakes 12a, 12b, 12c, and 12d may include, for example, a brake caliper mounted on the vehicle to engage a frictional element (such as a brake disc) that rotates with a vehicle wheel to effect braking of the associated vehicle wheel. The wheel brakes 12a, 12b, 12c, and 12d can be associated with any combination of front and rear wheels of the vehicle in which the brake system 10 is installed. A diagonally split brake system is illustrated such that the wheel brake 12a is associated with the left rear wheel, the wheel brake 12b is associated with the right front wheel, the wheel brake 12c is associated with the left front wheel, and the wheel brake 12d is associated with the right rear wheel. Alternatively for a vertically split system, the wheel brakes 12a and 12b may be associated with the front wheels, and the wheel brakes 12c and 12d may be associated with the rear wheels.

The brake system 10 includes a brake pedal unit, indicated generally at 14, a pedal simulator 16, a plunger assembly, indicated generally at 18, and a reservoir 20. The reservoir 20 stores and holds hydraulic fluid for the brake system 10. The fluid within the reservoir 20 is preferably held at or about atmospheric pressure but may store the fluid at other pressures if so desired. The brake system 10 may include a fluid level sensor (not shown) for detecting the fluid level of the reservoir 20. Note that in the schematic illustration of FIG. 1, conduit lines may not be specifically drawn leading to the reservoir 20 but may be represented by conduits ending and labelled with T1, T2, or T3 indicating that these various conduits are connected to one or more tanks or sections of the reservoir 20. Alternatively, the reservoir 20 may include multiple separate housings. As will be discussed in detail below, the plunger assembly 18 of the brake system 10 functions as a source of pressure to provide a desired pressure level to the wheel brakes 12a, 12b, 12c, and 12d during a typical or normal brake apply. Fluid from the wheel brakes 12a, 12b, 12c, and 12d may be returned to the plunger assembly 18 and/or diverted to the reservoir 20.

The brake system 10 includes an electronic control unit (ECU) 22. The ECU 22 may include microprocessors. The ECU 22 receives various signals, processes signals, and controls the operation of various electrical components of the brake system 10 in response to the received signals. The ECU 22 can be connected to various sensors such as pressure sensors, travel sensors, switches, wheel speed sensors, and steering angle sensors. The ECU 22 may also be connected to an external module (not shown) for receiving information related to yaw rate, lateral acceleration, longitudinal acceleration of the vehicle such as for controlling the brake system 10 during vehicle stability operation. Additionally, the ECU 22 may be connected to the instrument cluster for collecting and supplying information related to warning indicators such as an ABS warning light, a brake fluid level warning light, and a traction control/vehicle stability control indicator light.

The brake system 10 further includes first and second isolation valves 30 and 32. The isolation valves 30 and 32 may be solenoid actuated three-way valves. The isolation valves 30 and 32 are generally operable to two positions, as schematically shown in FIG. 1. The first and second isolation valves 30 and 32 each have a port in selective fluid communication with an output conduit 34 generally in communication with an output of the plunger assembly 18, as will be discussed below. The first and second isolation valves 30 and 32 also includes ports that are selectively in fluid communication with conduits 36 and 38, respectively, when the first and second isolation valves 30 and 32 are non-energized, as shown in FIG. 1. The first and second isolation valves 30 and 32 further include ports that are in fluid communication with conduits 40 and 42, respectively, which provide fluid to and from the wheel brakes 12a, 12b, 12c, and 12d.

In a preferred embodiment, the first and/or second isolation valves 30 and 32 may be mechanically designed such that flow is permitted to flow in the reverse direction (from conduit 34 to the conduits 36 and 38, respectively) when in their de-energized positions and can bypass the normally closed seat of the valves 30 and 32. Thus, although the 3-way valves 30 and 32 are not shown schematically to indicate this fluid flow position, it is noted that that the valve design may permit such fluid flow. This may be helpful in performing self-diagnostic tests of the brake system 10.

The system 10 further includes various solenoid actuated valves (slip control valve arrangement) for permitting controlled braking operations, such as ABS, traction control, vehicle stability control, and regenerative braking blending. A first set of valves includes a first apply valve 50 and a first dump valve 52 in fluid communication with the conduit 40 for cooperatively supplying fluid received from the first isolation valve 30 to the wheel brake 12a, and for cooperatively relieving pressurized fluid from the wheel brake 12a to a reservoir conduit 53 in fluid communication with the reservoir 20. A second set of valves includes a second apply valve 54 and a second dump valve 56 in fluid communication with the conduit 40 for cooperatively supplying fluid received from the first isolation valve 30 to the wheel brake 12b, and for cooperatively relieving pressurized fluid from the wheel brake 12b to the reservoir conduit 53. A third set of valves includes a third apply valve 58 and a third dump valve 60 in fluid communication with the conduit 42 for cooperatively supplying fluid received from the second isolation valve 32 to the wheel brake 12c, and for cooperatively relieving pressurized fluid from the wheel brake 12c to the reservoir conduit 53. A fourth set of valves includes a fourth apply valve 62 and a fourth dump valve 64 in fluid communication with the conduit 42 for cooperatively supplying fluid received from the second isolation valve 32 to the wheel brake 12d, and for cooperatively relieving pressurized fluid from the wheel brake 12d to the reservoir conduit 53. Note that in a normal braking event, fluid flows through the non-energized open apply valves 50, 54, 58, and 62. Additionally, the dump valves 52, 56, 60, and 64 are preferably in their non-energized dosed positions to prevent the flow of fluid to the reservoir 20.

The brake pedal unit 14 is connected to a brake pedal 70 and is actuated by the driver of the vehicle as the driver presses on the brake pedal 70. A brake sensor or switch 72 may be connected to the ECU 22 to provide a signal indicating a depression of the brake pedal 70. As will be discussed below, the brake pedal unit 14 may be used as a back-up source of pressurized fluid to essentially replace the normally supplied source of pressurized fluid from the plunger assembly 18 under certain failed conditions of the brake system 10. The brake pedal unit 14 can supply pressurized fluid in the conduits 36 and 38 (that are normally dosed off at the first and second isolation valves 30 and 32 during a normal brake apply) to the wheel brake 12a, 12b, 12c, and 12d as required.

The brake pedal unit 14 includes a housing having a multi-stepped bore 80 formed therein for slidably receiving various cylindrical pistons and other components therein. The housing may be formed as a single unit or include two or more separately formed portions coupled together. An input piston 82, a primary piston 84, and a secondary piston 86 are slidably disposed within the bore 80. The input piston 82 is connected with the brake pedal 70 via a linkage arm 76. Leftward movement of the input piston 82, the primary piston 84, and the secondary piston 86 may cause, under certain conditions, a pressure increase within an input chamber 92, a primary chamber 94, and a secondary chamber 96, respectively. Various seals of the brake pedal unit 14 as well as the structure of the housing and the pistons 82, 84, and 86 define the chambers 92, 94, and 96. For example, the input chamber 92 is generally defined between the input piston 82 and the primary piston 84. The primary chamber 94 is generally defined between the primary piston 84 and the secondary piston 86. The secondary chamber 96 is generally defined between the secondary piston 86 and an end wall of the housing formed by the bore 80.

The input chamber 92 is in fluid communication with the pedal simulator 16 via a conduit 100, the reason for which will be explained below. The input piston 82 is slidably disposed in the bore 80 of the housing of the brake pedal unit 14. An outer wall of the input piston 82 is engaged with a lip seal 102 and a seal 104 mounted in grooves formed in the housing. A passageway 106 (or multiple passageways) is formed through a wall of the piston 82. As shown in FIG. 1, when the brake pedal unit 14 is in its rest position (the driver is not depressing the brake pedal 70), the passageway 106 is located between the lip seal 102 and the seal 104. In the rest position, the passageway 106 permits fluid communication between the input chamber 92 and the reservoir 20 via a conduit 108. Sufficient leftward movement of the input piston 82, as viewing FIG. 1, will cause the passageway 106 to move past the lip seal 102, thereby preventing the flow of fluid from the input chamber 92 into the conduit 108 and the reservoir 20. Further leftward movement of the input piston 82 will pressurize the input chamber 92 causing fluid to flow into the pedal simulator 16 via the conduit 100. As fluid is diverted into the pedal simulator 16, a simulation chamber 110 within the pedal simulator 16 will expand causing movement of a piston 112 within the pedal simulator 16. Movement of the piston 112 compresses a spring assembly, schematically represented as a spring 114. The compression of the spring 114 provides a feedback force to the driver of the vehicle which simulates the forces a driver feels at the brake pedal 70 in a conventional vacuum assist hydraulic brake system, for example. The spring 114 of the pedal simulator 16 can include any number and types of spring members as desired. For example, the spring 114 may include a combination of low rate and high rate spring elements to provide a non-linear force feedback. The simulation chamber 110 is in fluid communication with the conduit 100 which is in fluid communication with the input chamber 92. A solenoid actuated simulator valve 116 is positioned within the conduit 100 to selectively prevent the flow of fluid from the input chamber 92 to the simulation chamber, such as during a failed condition in which the brake pedal unit 14 is utilized to provide a source of pressurized fluid to the wheel brakes. A check valve 118 in parallel with a restricted orifice 120 may be positioned with the conduit 100. The spring 114 of the pedal simulator 16 may be housed within a non-pressurized chamber 122 in fluid communication with the reservoir 20 (T1).

As discussed above, the input chamber 92 of the brake pedal unit 14 is selectively in fluid communication with the reservoir 20 via a conduit 108 and the passageway 106 formed in the input piston 82. The brake system 10 may include an optional simulator test valve 130 located within the conduit 108. The simulator test valve 130 may be electronically controlled between an open position, as shown in FIG. 1, and a powered closed position. The simulator test valve 130 is not necessarily needed during a normal boosted brake apply or for a manual push through mode. The simulator test valve 130 can be energized to a closed position during various testing modes to determine the correct operation of other components of the brake system 10. For example, the simulator test valve 130 may be energized to a closed position to prevent venting to the reservoir 20 via the conduit 108 such that a pressure build up in the brake pedal unit 14 can be used to monitor fluid flow to determine whether leaks may be occurring through seals of various components of the brake system 10.

The primary chamber 94 of the brake pedal unit 14 is in fluid communication with the second isolation valve 32 via the conduit 38. The primary piston 84 is slidably disposed in the bore 80 of the housing of the brake pedal unit 14. An outer wall of the primary piston 84 is engaged with a lip seal 132 and a seal 134 mounted in grooves formed in the housing. One or more passageways 136 are formed through a wall of the primary piston 84. The passageway 136 is located between the lip seal 132 and the seal 134 when the primary piston 84 is in its rest position, as shown in FIG. 1. Note that in the rest position the lip seal 132 is just slightly to the left of the passageway 136, thereby permitting fluid communication between the primary chamber 94 and the reservoir 20.

The secondary chamber 96 of the brake pedal unit 14 is in fluid communication with the first isolation valve 30 via the conduit 36. The secondary piston 86 is slidably disposed in the bore 80 of the housing of the brake pedal unit 14. An outer wall of the secondary piston 86 is engaged with a lip seal 140 and a seal 142 mounted in grooves formed in the housing, One or more passageways 144 are formed through a wall of the secondary piston 86. As shown in FIG. 1, the passageway 144 is located between the lip seal 140 and the seal 142 when the secondary piston 86 is in its rest position, Note that in the rest position the lip seal 140 is just slightly to the left of the passageway 144, thereby permitting fluid communication between the secondary chamber 96 and the reservoir 20 (T2).

If desired, the primary and secondary pistons 84 and 86 may be mechanically connected with limited movement therebetween. The mechanical connection of the primary and secondary pistons 84 and 86 prevents a large gap or distance between the primary and secondary pistons 84 and 86 and prevents having to advance the primary and secondary pistons 84 and 86 over a relatively large distance without any increase in pressure in the non-failed circuit. For example, if the brake system 10 is under a manual push through mode and fluid pressure is lost in the output circuit relative to the secondary piston 86, such as for example in the conduit 36, the secondary piston 86 will be forced or biased in the leftward direction due to the pressure within the primary chamber 94. If the primary and secondary pistons 84 and 86 were not connected together, the secondary piston 86 would freely travel to its further most left-hand position, as viewing FIG. 1, and the driver would have to depress the pedal 70 a distance to compensate for this loss in travel. However, because the primary and secondary pistons 84 and 86 are connected together, the secondary piston 86 is prevented from this movement and relatively little loss of travel occurs in this type of failure. Any suitable mechanical connection between the primary and secondary pistons 84 and 86 may be used. For example, as schematically shown in FIG. 1, the right-hand end of the secondary piston 86 may include an outwardly extending flange that extends into a groove formed in an inner wall of the primary piston 84. The groove has a width which is greater than the width of the flange, thereby providing a relatively small amount of travel between the first and secondary pistons 84 and 86 relative to one another.

The brake pedal unit 14 may include an input spring 150 generally disposed between the input piston 82 and the primary piston 84. Additionally, the brake pedal unit 14 may include a primary spring (not shown) disposed between the primary piston 84 and the secondary piston 86. A secondary spring 152 may be included and disposed between the secondary piston 86 and a bottom wall of the bore 80. The input, primary and secondary springs may have any suitable configuration, such as a caged spring assembly, for biasing the pistons in a direction away from each other and also to properly position the pistons within the housing of the brake pedal unit 14.

The brake system 10 may further include a pressure sensor 156 in fluid communication with the conduit 36 to detect the pressure within the secondary pressure chamber 96 and for transmitting the signal indicative of the pressure to the ECU 22. Additionally, the brake system 10 may further include a pressure sensor 158 in fluid communication with the conduit 34 for transmitting a signal indicative of the pressure at the output of the plunger assembly 18.

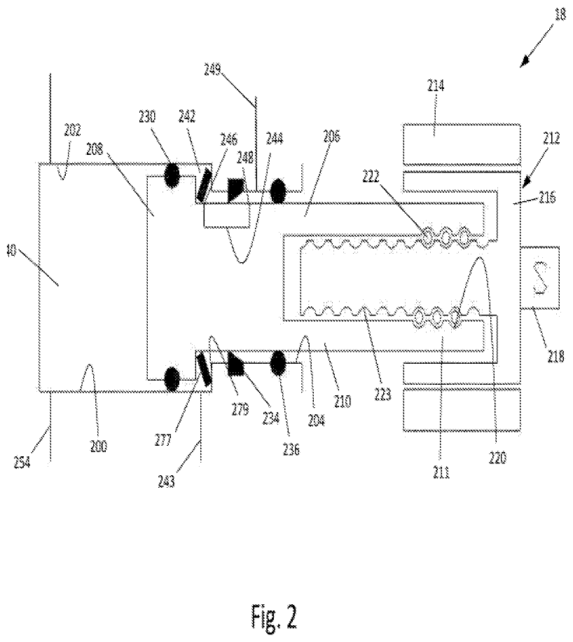

As shown schematically in FIG. 2, the plunger assembly 18 includes a housing having a multi-stepped bore 200 formed therein. The bore 200 includes a first portion 202 and a second portion 204. A piston 206 is slidably disposed within the bore 200. The piston 206 includes an enlarged end portion 208 connected to a smaller diameter central portion 210. The piston 206 has a second end 211 connected to a ball screw mechanism, indicated generally at 212. The ball screw mechanism 212 is provided to impart translational or linear motion of the piston 206 along an axis defined by the bore 200 in both a forward direction (leftward as viewing FIGS. 1 and 2), and a rearward direction (rightward as viewing FIGS. 1 and 2) within the bore 200 of the housing. In the embodiment shown, the ball screw mechanism 212 includes a motor 214 rotatably driving a screw shaft 216. The second end 211 of the piston 206 includes a threaded bore 220 and functions as a driven nut of the ball screw mechanism 212. The ball screw mechanism 212 includes a plurality of balls 222 that are retained within helical raceways 223 formed in the screw shaft 216 and the threaded bore 220 of the piston 206 to reduce friction. Although a ball screw mechanism 212 is shown and described with respect to the plunger assembly 18, it should be understood that other suitable mechanical linear actuators may be used for imparting movement of the piston 206. It should also be understood that although the piston 206 functions as the nut of the ball screw mechanism 212, the piston 206 could be configured to function as a screw shaft of the ball screw mechanism 212. Of course, under this circumstance, the screw shaft 216 would be configured to function as a nut having internal helical raceways formed therein. The piston 206 may include structures (not shown) engaged with cooperating structures formed in the housing of the plunger assembly 18 to prevent rotation of the piston 206 as the screw shaft 216 rotates around the piston 206. For example, the piston 206 may include outwardly extending splines or tabs (not shown) that are disposed within longitudinally extending grooves (not shown) formed in the housing of the plunger assembly 18 such that the tabs slide along within the grooves as the piston 206 travels in the bore 200.

As will be discussed below, the plunger assembly 18 is preferably configured to provide pressure to the conduit 34 when the piston 206 is moved in both the forward and rearward directions. The plunger assembly 18 includes a seal 230 mounted on the enlarged end portion 208 of the piston 206. The seal 230 slidably engages with the inner cylindrical surface of the first portion 202 of the bore 200 as the piston 206 moves within the bore 200. A seal 234 and a seal 236 are mounted in grooves formed in the second portion 204 of the bore 200. The seals 234 and 236 slidably engage with the outer cylindrical surface of the central portion 210 of the piston 206. A first pressure chamber 240 is generally defined by the first portion 202 of the bore 200, the enlarged end portion 208 of the piston 206, and the seal 230. An annular shaped second pressure chamber 242, located generally behind the enlarged end portion 208 of the piston 206, is generally defined by the first and second portions 202 and 204 of the bore 200, the seals 230 and 234, and the central portion 210 of the piston 206. The seals 230, 234, and 236 can have any suitable seal structure.

Although the plunger assembly 18 may be configured to any suitable size and arrangement, in one embodiment, the effective hydraulic area of the first pressure chamber 240 is greater than the effective hydraulic area of the annular shaped second pressure chamber 242. The first pressure chamber 240 generally has an effective hydraulic area corresponding to the diameter of the central portion 210 of the piston 206 (the inner diameter of the seal 234) since fluid is diverted through the first output conduit 254, second output conduit 243, and conduit 34 as the piston 206 is advanced in the forward direction. The second pressure chamber 242 generally has an effective hydraulic area corresponding to the diameter of the first portion 202 of the bore 200 minus the diameter of the central portion 210 of the piston 206. This configuration provides that on the back stroke in which the piston 206 is moving rearwardly, less torque (or power) is required by the motor 214 to maintain the same pressure as in its forward stroke. Besides using less power, the motor 214 may also generate less heat during the rearward stroke of piston 206. Under circumstances in which the driver presses on the pedal 70 for long durations, the plunger assembly 18 could be operated to apply a rearward stroke of the piston 206 to prevent overheating of the motor 214.

The plunger assembly 18 preferably includes a sensor, schematically shown as 218, for detecting the position of the piston 206 within the bore 200, The sensor 218 is in communication with the ECU 22. In one embodiment, the sensor 218 may detect the position of the piston 206, or alternatively, metallic or magnetic elements embedded with the piston 206. In an alternate embodiment, the sensor 218 may detect the rotational position of the motor 214 and/or other portions of the ball screw mechanism 212 which is indicative of the position of the piston 206. The sensor 218 can be located at any desired position.

The piston 206 of the plunger assembly 18 includes a passageway 244 formed therein. The passageway 244 defines a first port 246 extending through the outer cylindrical wall of the piston 206 and is in fluid communication with the secondary chamber 242. The passageway 244 also defines a second port 248 extending through the outer cylindrical wall of the piston 206 and is in fluid communication with a portion of the bore 200 located between the seals 234 and 236, The second port 248 is in fluid communication with a conduit 249 which is in fluid communication with the reservoir 20 (T3). When in the rest position, as shown in FIG. 2, the pressure chambers 240 and 242 are in fluid communication with the reservoir 20 via the conduit 249. This helps in ensuring a proper release of pressure at the output of the plunger assembly 18 and within the pressure chambers 240 and 242 themselves. After an initial forward movement of the piston 206 from its rest position, the port 248 will move past the lip seal 234, thereby dosing off fluid communication of the pressure chambers 240 and 242 from the reservoir 20, thereby permitting the pressure chambers 240 and 242 to build up pressure as the piston 206 moves further.

Referring back to FIG. 1, the brake system 10 further includes a first plunger valve 250, and a second plunger valve 252. The first plunger valve 250 is preferably a solenoid actuated normally closed valve. Thus, in the non-energized state, the first plunger valve 250 is in a dosed position, as shown in FIG. 1. The second plunger valve 252 is preferably a solenoid actuated normally open valve. Thus, in the non-energized state, the second plunger valve 252 is in an open position, as shown in FIG. 1. A check valve may be arranged within the second plunger valve 252 so that when the second plunger valve 252 is in its dosed position, fluid may still flow through the second plunger valve 252 in the direction from a first output conduit 254 (from the first pressure chamber 240 of the plunger assembly 18) to the conduit 34 leading to the isolation valves 30 and 32. Note that during a rearward stroke of the piston 206 of the plunger assembly 18, pressure may be generated in the second pressure chamber 242 for output into the conduit 34.

Generally, the first and second plunger valves 250 and 252 are controlled to permit fluid flow at the outputs of the plunger assembly 18 and to permit venting to the reservoir 20 (T3) through the plunger assembly 18 when so desired. For example, the first plunger valve 250 may be energized to its open position during a normal braking event so that both of the first and second plunger valves 250 and 252 are open (which may reduce noise during operation). Preferably, the first plunger valve 250 is almost always energized during an ignition cycle when the engine is running. Of course, the first plunger valve 250 may be purposely moved to its closed position such as during a pressure generating rearward stroke of the plunger assembly 18. The first and second plunger valves 250 and 252 are preferably in their open positions when the piston 206 of the plunger assembly 18 is operated in its forward stroke to maximize flow. When the driver releases the brake pedal 70, the first and second plunger valves 250 and 252 preferably remain in their open positions. Note that fluid can flow through the check valve within the closed second plunger valve 252, as well as through a check valve 258 from the reservoir 20 depending on the travel direction of the piston 206 of the plunger assembly 18.

It may be desirable to configure the first plunger valve 250 with a relatively large orifice therethrough when in its open position. A relatively large orifice of the first plunger assembly 250 helps to provide an easy flow path therethrough. The second plunger valve 252 may be provided with a much smaller orifice in its open position as compared to the first plunger valve 250. One reason for this is to help prevent the piston 206 of the plunger assembly 18 from rapidly being back driven upon a failed event due to the rushing of fluid through the first output conduit 254 into the first pressure chamber 240 of the plunger assembly 18, thereby preventing damage to the plunger assembly 18. As fluid is restricted in its flow through the relatively small orifice, dissipation will occur as some of the energy is transferred into heat. Thus, the orifice should be of a sufficiently small size so as to help prevent a sudden catastrophic back drive of the piston 206 of the plunger assembly 18 upon failure of the brake system 10, such as for example, when power is lost to the motor 214 and the pressure within the conduit 34 is relatively high. As shown in FIG. 2, the plunger assembly 18 may include an optional spring member, such as a spring washer 277, to assist in cushioning such a rapid rearward back drive of the piston 206, The spring washer 277 may also assist in cushioning the piston 206 moving at any such speed as it approaches a rest position near its most retracted position within the bore 200. Schematically shown in FIG. 2, the spring washer 277 is located between the enlarged end portion 208 and a shoulder 279 formed in the bore 200 between the first and second portions 202 and 204. The spring washer 277 can have any suitable configuration which deflects or compresses upon contact with the piston 206 as the piston 206 moves rearwardly. For example, the spring washer 277 may be in the form of a metal conical spring washer. Alternatively, the spring washer 277 may be in the form of a wave spring. Although the spring washer 277 is shown mounted within the bore 200 of the plunger assembly 18, the spring washer 277 may alternatively be mounted on the piston 206 such that the spring washer 277 moves with the piston 206. In this configuration, the spring washer 277 would engage with the shoulder 279 and compress upon sufficient rightward movement of the piston 206.

The first and second plunger valves 250 and 252 provide for an open parallel path between the pressure chambers 240 and 242 of the plunger assembly 18 during a normal braking operation. Although a single open path may be sufficient, the advantage of having both the first and second plunger valves 250 and 252 is that the first plunger valve 250 may provide for an easy flow path through the relatively large orifice thereof, while the second plunger valve 252 may provide for a restricted orifice path during certain failed conditions when the first plunger valve 250 is de-energized to its closed position.

During a typical or normal braking operation, the brake pedal 70 is depressed by the driver of the vehicle. In a preferred embodiment of the brake system 10, the brake pedal unit 14 includes one or more travel sensors 270 (for redundancy) for producing signals transmitted to the ECU 22 that are indicative of the length of travel of the input piston 82 of the brake pedal unit 14.

During normal braking operations, the plunger assembly 18 is operated to provide pressure to the conduit 34 for actuation of the wheel brakes 12a, 12b, 12c, and 12d, Under certain driving conditions, the ECU 22 communicates with a powertrain control module (not shown) and other additional braking controllers of the vehicle to provide coordinated braking during advanced braking control schemes (e.g., anti-lock braking (AB), traction control (TC), vehicle stability control (VSC), and regenerative brake blending). During a normal brake apply, the flow of pressurized fluid from the brake pedal unit 14, generated by depression of the brake pedal 70, is diverted into the pedal simulator 16. The simulator valve 116 is actuated to divert fluid through the simulator valve 116 from the input chamber 92. Note that the simulator valve 116 is shown in its energized state in FIG. 1. Thus, the simulator valve 116 is a normally closed solenoid valve. Also note that fluid flow from the input chamber 92 to the reservoir 20 is closed off once the passageway 106 in the input piston 82 moves past the seal 104.

During the duration of a normal braking event, the simulator valve 116 remains open, preferably. Also during the normal braking operation, the isolation valves 30 and 32 are energized to secondary positions to prevent the flow of fluid from the conduits 36 and 38 through the isolation valves 30 and 32, respectively. Preferably, the isolation valves 30 and 32 are energized throughout the duration of an ignition cycle such as when the engine is running instead of being energized on and off to help minimize noise. Note that the primary and secondary pistons 84 and 86 are not in fluid communication with the reservoir 20 due to their passageways 136 and 144, respectively, being positioned past the lip seals 132 and 140, respectively. Prevention of fluid flow through the isolation valves 30 and 32 hydraulically locks the primary and secondary chambers 94 and 96 of the brake pedal unit 14 preventing further movement of the primary and secondary pistons 84 and 86.

It is generally desirable to maintain the isolation valves 30 and 32 energized during the normal braking mode to ensure venting of fluid to the reservoir 20 through the plunger assembly 18 such as during a release of the brake pedal 70 by the driver. As best shown in FIG. 1, the passageway 244 formed in the piston 206 of the plunger assembly 18 permits this ventilation.

During normal braking operations, while the pedal simulator 16 is being actuated by depression of the brake pedal 70, the plunger assembly 18 can be actuated by the ECU 22 to provide actuation of the wheel brakes 12a, 12b, 12c, and 12d. The plunger assembly 18 is operated to provide desired pressure levels to the wheel brakes 12a, 12b, 12c, and 12d compared to the pressure generated by the brake pedal unit 14 by the driver depressing the brake pedal 70. The electronic control unit 22 actuates the motor 214 to rotate the screw shaft 216 in the first rotational direction. Rotation of the screw shaft 216 in the first rotational direction causes the piston 206 to advance in the forward direction (leftward as viewing FIGS. 1 and 2). Movement of the piston 206 causes a pressure increase in the first pressure chamber 240 and fluid to flow out of the first pressure chamber 240 and into the conduit 254. Fluid can flow into the conduit 34 via the open first and second plunger valves 250 and 252. Note that fluid is permitted to flow into the second pressure chamber 242 via a conduit 243 as the piston 206 advances in the forward direction. Pressurized fluid from the conduit 34 is directed into the conduits 40 and 42 through the isolation valves 30 and 32. The pressurized fluid from the conduits 40 and 42 can be directed to the wheel brakes 12a, 12b, 12c, and 12d through open apply valves 50, 54, 58, and 62 while the dump valves 52, 56, 60, and 64 remain closed. When the driver lifts off or releases the brake pedal 70, the ECU 22 can operate the motor 214 to rotate the screw shaft 216 in the second rotational direction causing the piston 206 to retract withdrawing the fluid from the wheel brakes 12a, 12b, 12c, and 12d. The speed and distance of the retraction of the piston 206 is based on the demands of the driver releasing the brake pedal 70 as sensed by the sensor 218. Under certain conditions, the pressurized fluid from the wheel brakes 12a, 12b, 12c, and 12d may assist in back-driving the ball screw mechanism 212 moving the piston 206 back towards its rest position.

In some situations, the piston 206 of the plunger assembly 18 may reach its full stroke length within the bore 200 of the housing and additional boosted pressure is still desired to be delivered to the wheel brakes 12a, 12b, 12c, and 12d, The plunger assembly 18 is a dual acting plunger assembly such that it is configured to also provide boosted pressure to the conduit 34 when the piston 206 is stroked rearwardly (rightward) or in a reverse direction. This has the advantage over a conventional plunger assembly that first requires its piston to be brought back to its rest or retracted position before it can again advance the piston to create pressure within a single pressure chamber. If the piston 206 has reached its full stroke, for example, and additional boosted pressure is still desired, the second plunger valve 252 is energized to its dosed check valve position. The first plunger valve 250 is de-energized to its closed position. The electronic control unit 22 actuates the motor 214 in a second rotational direction opposite the first rotational direction to rotate the screw shaft 216 in the second rotational direction. Rotation of the screw shaft 216 in the second rotational direction causes the piston 206 to retract or move in the rearward direction (rightward as viewing FIGS. 1 and 2). Movement of the piston 206 causes a pressure increase in the second pressure chamber 242 and fluid to flow out of the second pressure chamber 242 and into the conduit 243 and the conduit 34. Pressurized fluid from the conduit 34 is directed into the conduits 40 and 42 through the isolation valves 30 and 32. The pressurized fluid from the conduits 40 and 42 can be directed to the wheel brakes 12a, 12b, 12c, and 12d through the opened apply valves 50, 54, 58, and 62 while dump valves 52, 56, 60, and 64 remain dosed. In a similar manner as during a forward stroke of the piston 206, the ECU 22 can also selectively actuate the apply valves 50, 54, 58, and 62 and the dump valves 52, 56, 60, and 64 to provide a desired pressure level to the wheel brakes 12a, 12b, 12c, and 12d, respectively, When the driver lifts off or releases the brake pedal 70 during a pressurized rearward stroke of the plunger assembly 18, the first and second plunger valves 250 and 252 are preferably operated to their open positions, although having only one of the valves 250 and 252 open would generally still be sufficient. Note that when transitioning out of a slip control event, the ideal situation would be to have the position of the piston 206 and the displaced volume within the plunger assembly 18 correlate exactly with the given pressures and fluid volumes within the wheel brakes 12a, 12b, 12c, and 12d. However, when the correlation is not exact, fluid can be drawn from the reservoir 20 via the check valve 258 into the chamber 240 of the plunger assembly 18.

During a braking event, the ECU 22 can selectively actuate the apply valves 50, 54, 58, and 62 and the dump valves 52, 56, 60, and 64 to provide a desired pressure level to the wheel brakes, respectively. The ECU 22 can also control the brake system 10 during ABS, DRP, TC, VSC, regenerative braking, and autonomous braking events by general operation of the plunger assembly 18 in conjunction with the apply valves and the dump valves. Even if the driver of the vehicle is not depressing the brake pedal 70, the ECU 22 can operate the plunger assembly 18 to provide a source of pressurized fluid directed to the wheel brakes, such as during an autonomous vehicle braking event.

In the event of a loss of electrical power to portions of the brake system 10, the brake system 10 provides for manual push through or manual apply such that the brake pedal unit 14 can supply relatively high pressure fluid to the conduits 36 and 38. During an electrical failure, the motor 214 of the plunger assembly 18 might cease to operate, thereby failing to produce pressurized hydraulic brake fluid from the plunger assembly 18. The isolation valves 30 and 32 will shuttle (or remain) in their positions to permit fluid flow from the conduits 36 and 38 to the wheel brakes 12a, 12b, 12c, and 12d. The simulator valve 116 is shuttled to its closed position to prevent fluid from flowing out of the input chamber 92 to the pedal simulator 16. During the manual push-through apply, the input piston 82, the primary piston 84, and the secondary piston 86 will advance leftwardly such that the passageways 106, 136, 144 will move past the seals 102, 132, and 140, respectively, to prevent fluid flow from their respective fluid chambers 92, 94, and 96 to the reservoir 20, thereby pressurizing the chambers 92, 94, and 96. Fluid flows from the chambers 94 and 96 into the conduits 38 and 36, respectively, to actuate the wheel brakes 12a, 12b, 12c, and 12d.

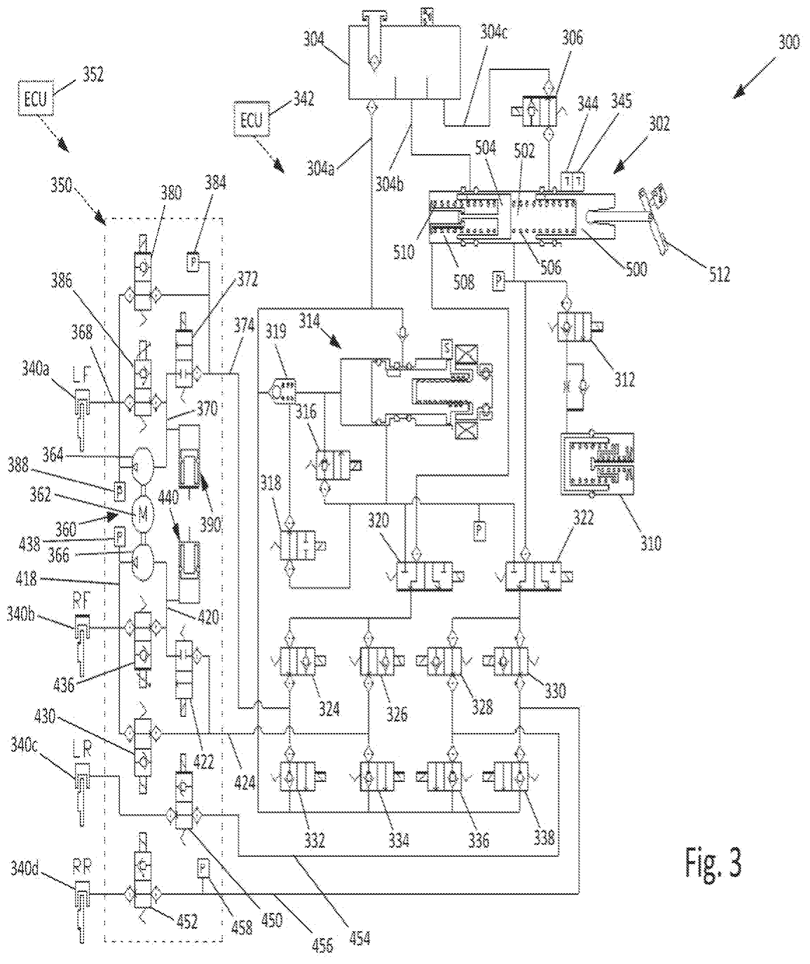

There is illustrated in FIG. 3, a second embodiment of a brake system, indicated generally at 300. The brake system 300 is similar in structure and function in many ways as the brake system 10 described above. As such, similarities between the brake systems 10 and 300 may not be discussed in duplication herein. The brake system 300 includes a brake pedal unit, indicated generally at 302. As will be described in greater detail below, the brake pedal unit 302 has a different design than the brake pedal unit 14 described above with respect to the brake system 10 in FIG. 1. The brake pedal unit 302 can have a simpler and, therefore, more cost effective design than the brake pedal unit 14. While a diagonal split system was previously described in FIGS. 1 and 2, it is understood that the second embodiment brake system 300 (having auxiliary EHCU 350) of FIG. 3 may be implemented on a front-rear split braking system and the second embodiment brake system 300 is not limited for use in a heavy duty truck vehicle.

The brake system 300 further includes a fluid reservoir 304. The fluid reservoir 304 is shown schematically having three sections with three conduit lines 304a, 304b, and 304c connected thereto. The sections can be separated by a couple of interior walls within the reservoir 304 and are provided to prevent complete drainage of the reservoir 304 in case one of the sections is depleted due to a leakage via one of the three conduits 304a, 304b, 304c connected to the reservoir 304.

The brake system 300 also includes a simulator test valve 306, a pedal simulator 310, and a simulator valve 312. Although the pedal simulator 310 is shown schematically having a more complex spring design, the pedal simulator 310 generally functions in a similar manner as the pedal simulator 16 of the brake system 10. The pedal simulator 310 may have a different “pedal feel” characteristic as felt by the driver during a normal brake apply due to the various different spring components within the pedal simulator 310.

The brake system 300 further includes a plunger assembly, indicated generally at 314 which functions in a similar manner as the plunger assembly 18 described above with respect to the brake system 10. First and second plunger valves 316 and 318 are located generally at the output of the plunger assembly 314 and function in a similar manner as the first and second plunger valves 250 and 252 of the brake system 10. A check valve 319 may be included at the outlet of the plunger assembly 314. The check valve 319 is disposed between the outlet of the plunger assembly 314 and the reservoir 304. Note that fluid can flow through the check valve 319 from the reservoir 304 depending on the travel direction of the piston of the plunger assembly 314 such as during release of the brake pedal 512.

The brake system 300 further includes first and second three way isolation valves 320 and 322, apply valves 324, 326, 328, 330, and dump valves 332, 334, 336, 338 which operate in a similar manner as the respectively named valves shown and described with respect to the brake system 10. A wheel brake 340a is preferably associated with the left front wheel of the vehicle in which the brake system 300 is installed. A wheel brake 340b is preferably associated with the right front wheel. A wheel brake 340c is preferably associated with the left rear wheel. A wheel brake 340d is preferably associated with the right rear wheel.

The brake system 300 also includes an electronic control unit (ECU) 342. The ECU 342 may include microprocessors and function in a similar manner as the ECU 22 of the brake system 10 described above. Thus, the ECU 342 receives various signals, processes signals, and controls the operation of various electrical components of the brake system 300 in response to the received signals. The ECU 342 can be connected to various sensors such as pressure sensors, travel sensors, switches, wheel speed sensors, and steering angle sensors. The ECU 342 may also be connected to an external module (not shown) for receiving information related to yaw rate, lateral acceleration, longitudinal acceleration of the vehicle such as for controlling the brake system 10 during vehicle stability operation. Additionally, the ECU 342 may be connected to the instrument duster for collecting and supplying information related to warning indicators such as an ABS warning light, a brake fluid level warning light, and a traction control vehicle stability control indicator light. The ECU 342 preferably is connected with a pair of travel sensors 344 and 345 mounted in the brake pedal unit 302. The travel sensors 344 and 345 produce signals transmitted to the ECU 342 that are indicative of the length of travel of a primary piston 500 (discussed below) of the brake pedal unit 302. The length of travel of the primary piston 500 may be indicative of the driver's intent of a desired braking force. The pair of travel sensors 344 and 345 may be included for redundancy versus having a single travel sensor.

One of the major differences between the brake systems 10 and 300 is that the brake system 300 includes an auxiliary electro-hydraulic control unit (EHCU), indicated generally at broken lines 350. The EHCU 350 may function as a second source of pressurized fluid for the front wheel brakes 340a and 340b, such as under certain failed conditions of the brake system 300 as will be explained below. For reasons explained below, the brake system 300 with the inclusion of the auxiliary EHCU 350 is ideally suited for vehicles, such as trucks that have wheel brakes requiring a relatively high volume of fluid for full operation thereof. The EHCU 350 and its components may be housed in a different block or unit remotely located from the remainder of the brake system 300, or may be housed integrally therewith.

The brake system 300 preferably includes a secondary ECU, indicated generally at 352. The secondary ECU 352 may include microprocessors and function in a similar manner as the ECUs 22 and 342 as described above. The secondary ECU 352 generally controls the operation of the components within the auxiliary EHCU 350, Thus, the secondary ECU 352 receives various signals, processes signals, and controls the operation of various electrical components of the auxiliary EHCU 350 in response to the received signals. At least one of the travel sensors 344 and/or 345 is connected to the secondary ECU 352. The secondary ECU 352 is separate from and located remotely from the main ECU 342. Moreover, it is understood that a separate pedal travel sensor may be dedicated to auxiliary EHCU 350.

The main ECU 342 and the secondary ECU 352 may both be connected to a vehicle CAN bus (Controller Area Network bus) for receiving various signals and controls. Both the main ECU 342 and the secondary ECU 352 may send out signals over the CAN bus indicating that they are operating properly. These signals may be received by the other of the ECU 342 and 352. For example, once the secondary ECU 352 does not receive the signal from the main ECU 342 over the CAN bus of proper operation of the main ECU 342, the secondary 352 may begin operating the EHCU 350, as will be described below. The main ECU 342 and the secondary ECU 352 function separately because if, for example, one ECU (main ECU 342) fails, the other ECU (secondary ECU 352) has to control the auxiliary EHCU 350.

Referring to FIG. 3, the auxiliary EHCU 350 includes a pump assembly, indicated generally at 360. In the embodiment shown, a single motor 362 drives first and second pumps 364 and 366. As will be explained below, the first pump 364 generally provides a source of pressurized fluid for the wheel brake 340a, while the second pump 366 generally provides a source of pressurized fluid for the wheel brake 340b. The pump assembly 360 can be any suitable pump assembly that provides for a source of pressurized fluid. For example, the motor 362 could be configured to drive or rotate a shaft having a pair of eccentric bearings for driving pumping elements of the first and second pumps 364 and 366. Alternatively, the motor 362 could be configured to drive separate eccentric shafts, one for each of the first and second pumps 364 and 366. In yet another embodiment, the pump assembly 360 can include separate motor and pumps for each of the first and second wheel brakes 340a and 340b.

The outlet of the first pump 364 is in fluid communication with the front wheel brake 340a via a first pump outlet conduit 368. When operated, the first pump 364 supplies pressurized fluid to the first pump outlet conduit 368. The inlet of the first pump 364 is in fluid communication with a first pump inlet conduit 370. The first pump inlet conduit 370 is in fluid communication with a solenoid actuated normally closed valve 372. The valve 372 is located between the first pump inlet conduit 370 and a first brake conduit 374. The first brake conduit 374 is in fluid communication with the main brake system 300. More specifically, the first brake conduit 374 is connected between the apply valve 324 and the dump valve 332 associated with the front wheel brake 340a.

A solenoid actuated normally open valve 380 is located between the first brake conduit 374 (from the main brake system 300) and the first pump outlet conduit 368. As will be discussed below, a normal braking event fluid path is created to the wheel brake 340a via the first brake conduit 374, the normally open valve 380, and the first pump outlet conduit 368. In a preferred embodiment, the normally open valve 380 has a relatively large orifice when in its open position such that under normal braking operations in which the auxiliary EHCU 350 is not engaged or operated, most (or all) of the fluid flowing from the first brake conduit 374 will pass through the valve 380 to the wheel brake 340a. For example, it is preferable to have an orifice sized for the valve 380 that is at least as large as the orifice of the apply valve 324 within its circuit. Of course, under certain conditions some fluid could be pushed through the pump assembly 352.

The auxiliary EHCU 350 further includes a pressure transducer or pressure sensor 384 for sensing the pressure within the first brake conduit 374. The pressure sensor 384 is connected to the secondary ECU 352. As will be explained below, the fluid pressure readings from the pressure sensor 374 may be used to determine the driver's demands during a manual push through event for proper operation of the auxiliary EHCU 350.

The auxiliary EHCU 350 also includes a solenoid actuated first pump valve 386 located between the inlet and the outlet of the first pump 364. More specifically, the first pump valve 386 is in fluid communication between the first pump inlet conduit 370 and the first pump outlet conduit 368. The first pump valve 386 is used to regulate the fluid pressure output of the first pump 364. If it is determined that the first pump 364 is providing too much pressure to the front wheel brake 340a, the first pump valve 386 can be operated to its open position to vent pressure build up in the first pump outlet conduit 368. The pump pressure is a function of the displaced brake P-V characteristics. In a preferred embodiment, the first pump valve 386 is a variable or proportional solenoid controlled valve such that more precise control can be achieved by altering the orifice area versus using a simple digital open/closed valve. Note that the pressure sensor 384 may be used to determine the drivers intent especially if the other sensors of the brake system 300 are inoperable due to a failed condition.

A pressure transducer or pressure sensor 388 is preferably included in the auxiliary EHCU 350 and is in fluid communication with the first pump outlet conduit 368. The pressure sensor 388 senses the fluid pressure at the outlet of the first pump 364 leading to the front wheel brake 340a. The pressure sensor 384 is connected to the secondary ECU 352.

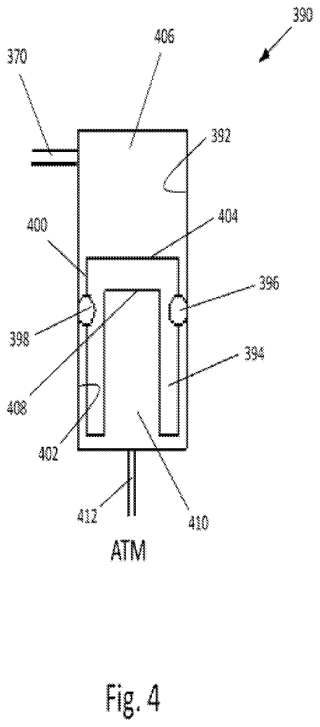

Referring to FIGS. 3 and 4, the auxiliary EHCU 350 further includes a first stored volume accumulator, indicated generally at 390. The first stored volume accumulator 390 is in fluid communication with the first pump inlet conduit 370. As will be discussed below, the first stored volume accumulator 390 generally provides for a predetermined amount of fluid to the inlet of the first pump 364 during operation of the auxiliary EHCU 350, such as during a faded braking event when the main brake system 300 is not able to be operated in a normal manner.

As shown in FIG. 4, the first stored volume accumulator 390 includes a housing defining a cylindrical bore 392. A cup shaped cylindrical piston 394 is slidably disposed in the bore 392. The piston 394 may include an elastomeric seal 396 disposed within a groove 398 formed in an outer surface 400 of the piston 394. The seal 396 engages with an inner cylindrical wall 402 of the bore 392. As schematically shown in FIG. 4, the elastomeric seal 396 is in the form for an O-ring. Of course, any suitable seal structure may be used for the seal 396 including multiple seal structures or seal structure(s) which are fixedly mounted on the housing instead of the piston 394. A first end 404 of the piston 394, the seal 396, and a portion of the bore 392 generally define a fluid chamber 406 of the stored volume accumulator 390. The fluid chamber 406 is filled with a predetermined volume of fluid which is determined by the dimensions of the components defining the fluid chamber 406. The fluid chamber 406 is in fluid communication with the first pump inlet conduit 370. A second end 408 of the piston 394, the seal 396, and a portion of the bore 392 generally define a vented chamber 410. The vented chamber 410 is preferably vented to atmosphere via a vent conduit 412. The first stored volume accumulator 390 preferably does not include any spring member biasing the piston 394. Of course, a spring member could be included to provide a slight bias to the piston 394 if so desired.

As shown in FIG. 3, first stored volume accumulator 390 is disposed downstream of the normally closed valve 372. The normally dosed valve 372 may also be referenced as an isolation driver valve. Moreover, as shown in FIG. 3, volume of pressure medium from the first stored accumulator 390 may flow directly to (the inlet of) pump 364. Subsequently, valve 372 may be opened so that pressure medium may then be drawn from first brake conduit 374 for use in the wheel brake(s), such as, for example brake 340a. Similarly, second stored volume accumulator 440 is disposed downstream of the normally closed valve 422. This normally dosed valve 422 may also be referenced as an isolation driver valve. Moreover, as shown in FIG. 3, volume of pressure medium from the second stored accumulator 440 may flow directly to (the inlet of) pump 366. Subsequently, valve 422 may be opened so that pressure medium may then be drawn from the second brake conduit 424 to the brake(s), such as, for example brake 340b.

The secondary unit 350 includes various components associated with the front wheel brake 340b in a similar manner with respect to the front wheel brake 340a as described above. For example, the wheel brake 340a may be associated with the left front wheel of the vehicle, while the wheel brake 340b may be associated with the right front wheel of the vehicle. These components are generally similar in structure and function as discussed below.

The outlet of the second pump 366 is in fluid communication with the front wheel brake 340b via a second pump outlet conduit 418. When operated, the second pump 366 supplies pressurized fluid to the second pump outlet conduit 418, The inlet of the second pump 366 is in fluid communication with a second pump inlet conduit 420. The second pump inlet conduit 420 is in fluid communication with a solenoid actuated normally closed valve 422. The valve 422 is located between the second pump inlet conduit 420 and a second brake conduit 424. The second brake conduit 424 is in fluid communication with the main brake system 300. More specifically, the second brake conduit 424 is connected between the apply valve 326 and the dump valve 334 associated with the front wheel brake 340b.

A solenoid actuated normally open valve 430 is located between the second brake conduit 424 (from the main brake system 300) and the second pump outlet conduit 418. As will be discussed below, a normal braking event fluid path is created to the wheel brake 340b via the second brake conduit 424, the normally open valve 430, and the second pump outlet conduit 418. Similar to the first normally open valve 380, the normally open valve 430 preferably has a relatively large orifice when in its open position such that under normal braking operations in which the auxiliary EHCU 350 is not engaged or operated, most (or all) of the fluid flowing from the second brake conduit 424 will pass through the valve 430 to the wheel brake 340b.

The auxiliary EHCU 350 also includes a solenoid actuated second pump valve 436 located between the inlet and the outlet of the second pump 366. More specifically, the second pump valve 436 is in fluid communication between the second pump inlet conduit 420 and the second pump outlet conduit 418. The second pump valve 436 is used to regulate the fluid pressure output of the second pump 366 in a similar manner as the first pump valve 386 regulates the fluid pressure output of the first pump 364 as described above. Similarly, in a preferred embodiment, the second pump valve 436 is a variable or proportional solenoid controlled valve. Note that the pressure sensor 384 may also be used to determine the driver's intent even though it is connected to the fluid circuit associated with the front wheel brake 340a.

Another pressure transducer or pressure sensor 438 is preferably included in the auxiliary EHCU 350 and is in fluid communication with the second pump outlet conduit 418. The pressure sensor 438 senses the fluid pressure at the outlet of the second pump 366 leading to the front wheel brake 340b. The pressure sensor 438 is connected to the secondary ECU 352. The auxiliary EHCU 350 further includes a second stored volume accumulator, indicated generally at 440. The second stored volume accumulator 440 is in fluid communication with the second pump inlet conduit 420. The second stored volume accumulator 440 is similar in structure and function as the first stored volume accumulator 390, and as such, will not be described in duplicate here.

With respect to rear brake circuits of the brake system 300, the auxiliary EHCU 350 preferably further includes first and second leak isolation valves 450 and 452. The first and second leak isolation valves 450 and 452 are preferably normally open solenoid actuated valves. The first leak isolation valve 450 is located within a third brake conduit 454 that connects the wheel brake 340c to the main brake system 300. More specifically, the third brake conduit 454 is in fluid communication with the wheel brake 340c at one end and connected between the apply valve 328 and the dump valve 336 at the other end. The second leak isolation valve 452 is located within a fourth brake conduit 456 that connects the wheel brake 340d to the main brake system 300. More specifically, the fourth brake conduit 456 is in fluid communication with the wheel brake 340d at one end and connected between the apply valve 328 and the dump valve 336 at the other end. The reason for the first and second leak isolation valves 450 and 452 will be discussed below.

The auxiliary EHCU 350 also preferably includes a pressure transducer or pressure sensor 458 sensing the pressure within one of the third and fourth brake conduits 454 and 456. In the embodiment shown, the pressure sensor 458 is connected to the third brake conduit 454 and is provided for sensing the fluid pressure in the rear circuit. The pressure sensor 458 is connected to the secondary ECU 352. It is noted that only a single pressure sensor 458 may be necessary to sense the pressure in the rear circuit (associated with the wheel brakes 340c and 340d). Similarly, only a single pressure sensor 384 is used to sense the pressure in the front circuit (associated with the wheel brakes 340a and 340b). If desired, additional sensors (not shown) could be added and connected to the second brake conduit 424 and the fourth brake conduit 456.

Another difference between the brake systems 10 and 300 is that the brake pedal unit 302 of the brake system 300 may have a simpler design than the brake pedal unit 14. The brake pedal unit 302 may be more comparable to a conventional master cylinder thus having a more cost effective design. The brake pedal unit 302 includes a primary piston 500 such that leftward movement of the primary piston 500 causes a pressure increase in a primary chamber 502. A secondary piston 504 is spaced from and biased from the primary piston 500 by a spring 506. Leftward movement of the secondary piston 504 pressurizes a secondary chamber 508. A caged spring assembly 510 is located within the secondary chamber 508 and spaces the secondary piston 504 from the primary piston 500.

Under normal braking operations, the driver depresses a brake pedal 512 which causes movement of the primary and secondary pistons 500 and 504 until fluid communication is closed off from the primary and secondary chambers 502 and 508 to the reservoir 304 (in a similar manner as described above with respect to the brake pedal unit 14). Fluid is then diverted from the primary chamber 502 into the pedal simulator 310. The isolation valves 320 and 322 are preferably energized to prevent the flow of fluid in a direction from the primary and secondary chambers 502 and 508 to the wheel brakes. The main ECU 342 then controls the plunger assembly 314 to provide the desired fluid pressure to the wheel brakes 340a, 340b, 340c, and 340d, as discussed above with respect to the brake system 10.

It is noted that under normal braking operations that for the front wheel circuit, fluid flows from the first and second brake conduits 374 and 424, through the normally open valves 380 and 430, through the first and second pump outlet conduits 368 and 418, respectively, to the front wheel brakes 340a and 340b. It is also noted that the volume of fluid within the secondary chamber 508 of the brake pedal unit 302 retains its general maximum volume. With respect to the rear circuit, during a normal braking event, fluid flows from the third and fourth brake conduits 454 and 456, through the normally open leak isolation valves 450 and 452, respectively, to the rear wheel brakes 340c and 340d.

The brake system 300 is ideally suited for vehicles, such as trucks, that have wheel brakes requiring a relatively high volume of fluid for full operation thereof. Thus, these vehicles may demand a brake system capable of providing a relatively large volume of fluid to the wheel brakes (especially front wheel brakes) compared to brake systems designed for smaller passenger vehicles. This may be especially true in a failed condition when the brake system is undergoing a manual push through operation. The brake system 300 can provide such a large volume of fluid for the front wheel brakes 340a and 340b via the first and second stored volume accumulators 390 and 440 of the auxiliary EHCU 350. For example, if an electrical failure occurred in the brake system 300, the auxiliary EHCU 350 may be operated to provide an additional boost of fluid to the front wheel brakes 340a and 340b. The auxiliary EHCU 350 may be located remotely and/or electrically disconnected from the main brake system 300 for such a reason. While the auxiliary EHCU 350 is schematically shown as element 350 in FIG. 3, it is understood that the remaining components of the brake system 300 (with the exception of the wheel brakes 340a, 340b, 340c, 340d) of FIG. 3 may be disposed together as part of a single unit (or primary EHCU).

The operation of the auxiliary EHCU 350 will now be explained relative to the brake system 300 undergoing a manual push through event such as during a failure of the normal operation of the brake system 300. During a manual push through event, the plunger assembly 314 is not used to provide pressurized fluid to the wheel brakes. For example, the plunger assembly 314 may have faded, or alternatively, an electrical failure may have occurred within the brake system 300 such that use of the main ECU 352 is not available. Thus, a manual push through operation of the brake system 300 is now used to provide adequate braking force at the wheel brakes. If a faded condition occurred prior to the driver applying the brakes (pushing on the brake pedal 512), when the driver pushes on the brake pedal 512, fluid from the primary and secondary chambers 502 and 508 of the brake pedal unit 302 will initially be diverted through the deenergized three way isolation valves 320 and 322. The rear wheel brakes 340c and 340d will receive pressurized fluid from the primary chamber 502 of the brake pedal unit 302 during the manual push through event as the brake pedal 512 is depressed. Note that the normally open first and second leak isolation valves 450 and 452 remain in their open positions (deenergized).

The front circuit associated with the front wheel brakes 340a and 340b is operated differently from the rear circuit associated with the rear wheel brakes 340c and 340d. Unlike the rear circuit, fluid is generally not diverted through the three way isolation valve 320 during the manual push through event. Instead, the auxiliary EHCU 350 may be operated by the secondary ECU 452 to start up and engage the pump assembly 360. Also during this initial start up phase, the normally open valves 380 and 430 are energized to their closed positions. The normally closed valves 372 and 422 remain in their closed positons. The first and second pump valves 386 and 436 are energized to permit pressure build up. Upon actuation, the pump assembly 360 quickly engages the first and second pumps 364 and 366 to provide a rapid increase in fluid pressure within the first and second pump outlet conduits 368 and 418 which is supplied to the front wheel brakes 340a and 340b. Note that the pump assembly 360 is usually operated via the secondary ECU 352 such that the pressure within the first and second pump outlet conduits 368 and 418 is greater than the pressure within the first and second brake conduits 374 and 424 from the brake pedal unit 302.

The auxiliary EHCU 350 is regulated and modulated by the secondary ECU 352 to provide the desired pressure to the wheel brakes 340a and 340b. If the pump assembly 360 is providing too much pressure to the system, the first and second pump valves 386 and 436 can be operated to their open positions to vent pressure build up in the first and second pump outlet conduits 368 and 418. Note that readings from the pressure sensors 388 and 438 to the secondary ECU 352 may be used to determine the pressure at the wheel brakes 340a and 340b. Readings from the pressure sensor 384 may be used to help determine the driver's demand or intent especially if the other sensors of the brake system 300 are inoperable due to the failed condition. Additionally, information from one of the travel sensors 344 or 345 connected to the secondary ECU 352 may be used to determine the driver's demand.

It is noted that the addition of the auxiliary EHCU 350 reduces the necessary pedal travel of the brake pedal unit 350 since the volume of fluid within the brake pedal unit 350 (secondary chamber 508) is generally not used during a manual push through event. Thus, the brake pedal 512 is not depressed an additional amount to move the secondary piston 504 to compress or reduce the volume of the secondary chamber 508. This reduction of pedal travel compared to brake systems without an auxiliary EHCU 350 is one of the advantages of the brake system 300.

The pump assembly 360 could be designed in a relatively simple manner such that the motor runs at a single or full speed providing the maximum output of the first and second pumps 364 and 366. The pump valves 386 and 436 can then be controlled between closed and open positions to regulate the desired pressure level within the first and second pump outlet conduits 368 and 418. However, the pump assembly 360 could be designed such that the motor 362 is regulated to provide a range of desired pump pressure outputs.

The first and second stored volume accumulators 390 and 440 provide the necessary volume of fluid to the inlets of the first and second pumps 364 and 366 for proper operation of the auxiliary EHCU 3S0 under most circumstances, The first and second stored volume accumulators 390 and 440 are designed to hold a relatively large amount of fluid to accommodate the demands of the front wheel brakes 340a and 340b. However, in cases of extreme pressure level demands or due to leakage within the system, the first and second stored volume accumulators 390 and 440 could be depleted of fluid. If this depletion scenario has been determined by the secondary ECU 3S2, the secondary ECU 3S2 can energize the normally closed valves 372 and 422 to their open positions to introduce fluid from the first and second brake conduits 374 and 424 to the inlet of the first and second pumps 363 and 366. The fluid from the first and second brake conduits 374 and 424 is provided by the volume of fluid within the secondary chamber S08 of the brake pedal unit 302.

The determination of whether the first and second stored volume accumulators 390 and 440 have been depleted can be estimated by the secondary ECU 352. For example, if it is known from the design of the front wheel brakes 340a and 340b that a relatively high pressure of about 100 bar will be reached with about 6 cc of fluid volume, the first and second stored volume accumulators 390 and 440 could be designed to accommodate 6 cc within their fluid chambers 406. If during the manual push through event it is found that the wheel brakes 340a and 340b are experiencing 100 bar of pressure, such as from the pressure sensors 388 and 438, it can be determined that the first and second stored volume accumulators 390 and 440 are probably depleted.

Preferably, the valves 380 and 430 remain energized in their closed positions during the event. As the driver releases the brake pedal S12 to end the manual push through braking event, fluid is diverted from the wheel brakes 340a and 340b back into the first and second stored volume accumulators 390 and 440. However, in case pressure remains in the front wheel brakes 340a and 340b, fluid can flow through the valves 380 and 430 when they are deenergized by the secondary ECU 352.

Although use of the auxiliary EHCU 350 was described above with respect to being used during a failure of one or more of the components of the brake system 300, such as during a manual push through event, the auxiliary EHCU 350 could be triggered on during a non-failed braking event. Under circumstances when it is desirable to increase the flow volume to the front wheel brakes 340a and/or 340b, the auxiliary EHCU 350 could be activated. For example, the auxiliary EHCU 350 could be used during an autonomous driving event when the driver is not depressing the brake pedal 512 and, therefore, no pressure is being generated by the brake pedal unit 302.

The auxiliary EHCU 350 also provides for an improved fail-safe feature in that a brake circuit associated with one of the wheel brakes 340a, 340b, 340c, 340d can be isolated from the rest of the brake system 300 if a fluid leak is detected. This isolation helps prevents further loss of fluid from the brake system 300 caused by the leak. It is preferred to limit any loss of fluid from the brake system 300 because this can have an adverse effect in decelerating the vehicle. With the design of the brake system 300, the isolation can be done at each individual wheel brake 340a, 340b, 340c, or 340d, or the brake system 300 can isolate axles (ex: front axle v. rear axle) from one another. For example, the first circuit 351 associated with the front wheel brakes 340a and 340b can be isolated together. Similarly, the second circuit 353 associated with the rear wheel brakes 340c and 340d can be isolated together.

For example, if it was determined that a leakage has occurred in the right rear wheel brake 340d, the secondary ECU 352 could energize the second leak isolation valve 452 to prevent the further loss of fluid out of the fourth brake conduit 456. If the leak is detected during a manual push through event, this reduces brake pedal travel since fluid from the brake system 300 is not being further spilled out from the brake pedal unit 302. If a leak has occurred in the front circuit, one or both of the normally open valves 380 and/or 430 van be energized to their closed position. During a leak detection event, a warning indicator may be given to the driver of the vehicle that the brake system 300 is not operating properly and requires maintenance. It may also be desirable to run self-diagnostic tests to determine if a leakage may have occurred somewhere within the brake system 300.

Although the brake system 300 was shown and described above having stored volume accumulators and pump assemblies on only the front circuit, it should be understood that the brake system 300 could be modified to include those features on the rear circuit as well. For this configuration, the first and second leak isolations valves 450 and 452 can be removed. The pump assembly 360 could be modified to include a second eccentric shaft or bearing on the motor 362 for operating two additional pumps, one for each of the wheel brakes 340c and 340d. Each of the added pumps can be connected to additional stored volume accumulators. At each of the wheel brakes 340c and 340d would be the addition of a normal open valve, normally closed valve, and pump regulator valve in a similar configuration as the front circuit shown in FIG. 3.

With respect to the various valves of the brake system 10, the terms “operate” or “operating” (or “actuate” “moving”, “positioning”) used herein (including the claims) may not necessarily refer to energizing the solenoid of the valve, but rather refers to placing or permitting the valve to be in a desired position or valve state. For example, a solenoid actuated normally open valve can be operated into an open position by simply permitting the valve to remain in its non-energized normally open state. Operating the normally open valve to a closed position may include energizing the solenoid to move internal structures of the valve to block or prevent the flow of fluid therethrough. Thus, the term “operating” should not be construed as meaning moving the valve to a different position nor should it mean to always energizing an associated solenoid of the valve,

The principle and mode of operation of this invention have been explained and illustrated in its preferred embodiment. However, it must be understood that this invention may be practiced otherwise than as specifically explained and illustrated without departing from its spirit or scope.

What is claimed is:

1. A brake system comprising:
a fluid reservoir;
a brake pedal unit in fluid communication with the fluid reservoir, the brake pedal unit including a housing and a pair of pistons slidably disposed in the housing, the pistons operable during a manual push-through mode such that the pair of pistons are movable to generate brake actuating pressure at first and second outputs for actuating at least one wheel brake within a first and second circuit respectively;
a first source of pressurized fluid for actuating the at least one wheel brake under normal braking conditions;
a pump assembly for actuating the at least one wheel brake during the manual push-through mode; and
a valve for selectively closing off fluid communication between an inlet of the pump assembly and the brake pedal unit;
wherein the pump assembly and the valve are disposed within an auxiliary EHCU configured to provide a fail-safe feature so as to actuate the at least one wheel brake in the event that the manual push through mode arises.

2. The brake system of claim 1, wherein the valve is a normally closed solenoid actuated valve.

3. The brake system of claim 1 further including a stored volume accumulator separate from the fluid reservoir, and wherein the stored volume accumulator is in fluid communication with the inlet of the pump assembly.

4. The brake system of claim 3, wherein the stored volume accumulator includes a piston slidably mounted therein having a first end defining a fluid pressure chamber, and wherein a second end of the piston defines an air-filled chamber at atmospheric pressure.

5. The brake system of claim 1, wherein the second source of pressurized fluid includes a pump assembly having an electric motor and a pump.

6. The brake system of claim 1, wherein the first source of pressurized fluid includes a plunger assembly.

7. A brake system comprising:
a fluid reservoir;
a brake pedal unit in fluid communication with the fluid reservoir, the brake pedal unit including a housing and a pair of pistons slidably disposed in the housing, the pistons operable during a manual push-through mode such that the pair of pistons are movable to generate brake actuating pressure at first and second outputs conduits which are in fluid communication with first and second circuits respectively;
a first source of pressurized fluid for actuating at least one wheel brake under normal braking conditions;
a pump assembly for actuating at least one wheel brake under the manual push-through mode;
a valve for selectively closing off fluid communication between an inlet of the pump assembly and the brake pedal unit; and
an accumulator disposed downstream of the valve and the accumulator being configured to initially provide a pressure medium stored within the accumulator to the pump;
wherein the pump assembly and the valve are disposed within an auxiliary EHCU which is configured to provide a fail-safe feature so as to actuate the at least one wheel brake when in the manual push through mode.

8. The brake system as defined in claim 7 wherein the valve is configured to open upon exhausting the pressure medium from the accumulator so that an additional pressure medium may then be drawn from a brake conduit to a brake.

9. The brake system as defined in claim 8 wherein the valve and the accumulator are dedicated for use with the at least one wheel brake which corresponds to the valve and the accumulator.

10. The brake system as defined in claim 9 further comprising:
a second valve;
a second pump; and
a second accumulator where the second accumulator is disposed downstream of the second valve;
wherein the second accumulator is configured to feed pressure medium to the second pump and
wherein the second valve is configured to open upon exhausting the pressure medium from the second accumulator so that a second brake conduit can simultaneously deliver pressure medium to a second brake while the first brake conduit is delivering pressure medium to the at least one wheel brake which corresponds to the first brake circuit.
